(19) United States
(12) Patent Application Publication
(10) Pub. No.: US 2016/0305254 A1
(43) Pub. Date: Oct. 20, 2016

(54) ROTOR BLADE PLATFORM COOLING PASSAGE

(71) Applicant: UNITED TECHNOLOGIES CORPORATION, Hartford, CT (US)

(72) Inventors: Daniel A. SNYDER, Manchester, CT (US); Jeffrey S. BEATTIE, South Glastonbury, CT (US)

(21) Appl. No.: 15/100,413

(22) PCT Filed: Nov. 17, 2014
(86) PCT No.: PCT/US2014/065857

§ 371 Date: May 31, 2016

Related U.S. Application Data
(60) Provisional application No. 61/916,856, filed on Dec. 17, 2013.

(51) Int. Cl. F01D 5/18; F04D 29/58; F04D 29/32

(52) U.S. Cl. CPC F01D 5/187; F01D 5/186; F04D 29/324; F04D 29/582; F05D 2240/81; F05D 2260/202; F05D 2260/201

(57) ABSTRACT

A rotor blade according to an exemplary aspect of the present disclosure includes, among other things, a platform, an airfoil that extends from the platform and a platform cooling passage extending inside of the platform. The platform cooling passage includes an inlet disposed through a non-gas path surface of the platform and an outlet disposed through a mate face of the platform.

### STATEMENT REGARDING FEDERALLY SPONSORED RESEARCH OR DEVELOPMENT

This invention was made with government support under Contract No. FA8650-09-D-2923-0021, awarded by the United States Air Force. The Government therefore has certain rights in this invention.

### BACKGROUND

This disclosure relates to a gas turbine engine, and more particularly to a gas turbine engine rotor blade having a platform cooling passage.

Gas turbine engines typically include a compressor section, a combustor section, and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections of a gas turbine engine may include alternating rows of rotating blades and stationary vanes that extend into the core flow path of the engine. For example, in the turbine section, turbine blades rotate to extract energy from the hot combustion gases. The turbine vanes direct the combustion gases at a preferred angle of entry relative to the downstream row of blades. Blades and vanes are examples of components that may need cooled by a dedicated source of cooling air in order to withstand the relatively high temperatures of the hot combustion gases they are exposed to.

### SUMMARY

A rotor blade according to an exemplary aspect of the present disclosure includes, among other things, a platform, an airfoil that extends from the platform and a platform cooling passage extending inside of the platform. The platform cooling passage includes an inlet disposed through a non-gas path surface of the platform and an outlet disposed through a mate face of the platform.

In a further non-limiting embodiment of the foregoing rotor blade, the platform cooling passage includes a curved section that leads into the outlet.

In a further non-limiting embodiment of either of the foregoing rotor blades, the inlet is fed with a cooling fluid communicated through a neck pocket disposed in a neck of a root that extends from the platform.

In a further non-limiting embodiment of any of the foregoing rotor blades, the inlet is fed with a cooling fluid from a forward rim cavity.

In a further non-limiting embodiment of any of the foregoing rotor blades, the forward rim cavity is radially inward from the platform and is upstream from a root that extends from the platform.

In a further non-limiting embodiment of any of the foregoing rotor blades, at least one augmentation feature is formed inside the platform cooling passage.

In a further non-limiting embodiment of any of the foregoing rotor blades, the outlet is positioned at a trailing edge of the airfoil.

In a further non-limiting embodiment of any of the foregoing rotor blades, the outlet is positioned upstream from a trailing edge of the airfoil.

In a further non-limiting embodiment of any of the foregoing rotor blades, the outlet is positioned downstream from a trailing edge of the airfoil.

In a further non-limiting embodiment of any of the foregoing rotor blades, the platform cooling passage is positioned adjacent to a pressure side of the airfoil.

In a further non-limiting embodiment of any of the foregoing rotor blades, the platform cooling passage is positioned adjacent to a suction side of the airfoil.

In a further non-limiting embodiment of any of the foregoing rotor blades, the outlet includes a plurality of outlet openings formed through the mate face.

A gas turbine engine according to another exemplary aspect of the present disclosure includes, among other things, a rotor blade including a platform an airfoil that extends from the platform and a platform cooling passage extending inside of the platform. The platform cooling passage includes an inlet fed with a cooling fluid from either a front rim cavity upstream of the rotor blade or a neck pocket formed through a root of the rotor blade and an outlet disposed through a mate face of the platform.

In a further non-limiting embodiment of the foregoing gas turbine engine, the inlet is disposed through a non-gas path surface of the platform upstream from a leading edge of the airfoil.

In a further non-limiting embodiment of either of the foregoing gas turbine engines, the inlet is disposed between a leading edge and a midpoint of the airfoil.

A method of cooling a platform of a rotor blade according to another exemplary aspect of the present disclosure includes, among other things, communicating a cooling fluid into an inlet of a platform cooling passage, the inlet formed in a non-gas path surface of the platform, circulating the cooling fluid through the platform cooling passage to remove heat from the platform and expelling the cooling fluid through an outlet of the platform cooling passage, the outlet disposed through a mate face of the platform.

In a further non-limiting embodiment of the foregoing method, the method includes feeding the cooling fluid to the platform cooling passage from a forward rim cavity located radially inward of the platform.

In a further non-limiting embodiment of either of the foregoing methods, the method includes feeding the cooling fluid through a neck pocket formed in a root of the rotor blade.

In a further non-limiting embodiment of any of the foregoing methods, the method includes depositing a film cooling layer at the mate face to discourage gas ingestion into a mate face gap between adjacent rotor blades.

In a further non-limiting embodiment of any of the foregoing methods, the method includes communicating the cooling fluid through a curved section of the platform cooling passage prior to the step of expelling.

The embodiments, examples and alternatives of the preceding paragraphs, the claims, or the following descriptions and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a schematic, cross-sectional view of a gas turbine engine.

FIG. 2 illustrates a rotor blade that can be utilized by a gas turbine engine.

FIG. 3 illustrates a top view of the rotor blade of FIG. 2.

FIG. 4 illustrates a platform cooling passage of a rotor blade according to one embodiment of this disclosure.

FIG. 5 illustrates a platform cooling passage of a rotor blade according to another embodiment of this disclosure.

FIG. 6 illustrates a platform cooling passage of a rotor blade according to yet another embodiment of this disclosure.

FIG. 7 illustrates a cross-sectional view of a rotor blade.

FIG. 8 illustrates another exemplary rotor blade.

FIG. 9 illustrates yet another exemplary rotor blade.

### DETAILED DESCRIPTION

This disclosure relates to a gas turbine engine rotor blade. The rotor blade includes a platform cooling passage that can be fed with a cooling fluid supplied from either a forward rim cavity or a neck pocket. The cooling passage includes an inlet through a non-gas path surface of a platform of the blade and an outlet at a mate face of the platform. The outlet may be positioned at a trailing edge of an airfoil of the blade, aft of the airfoil trailing edge, or forward of the airfoil trailing edge. These and other features are described in detail herein.

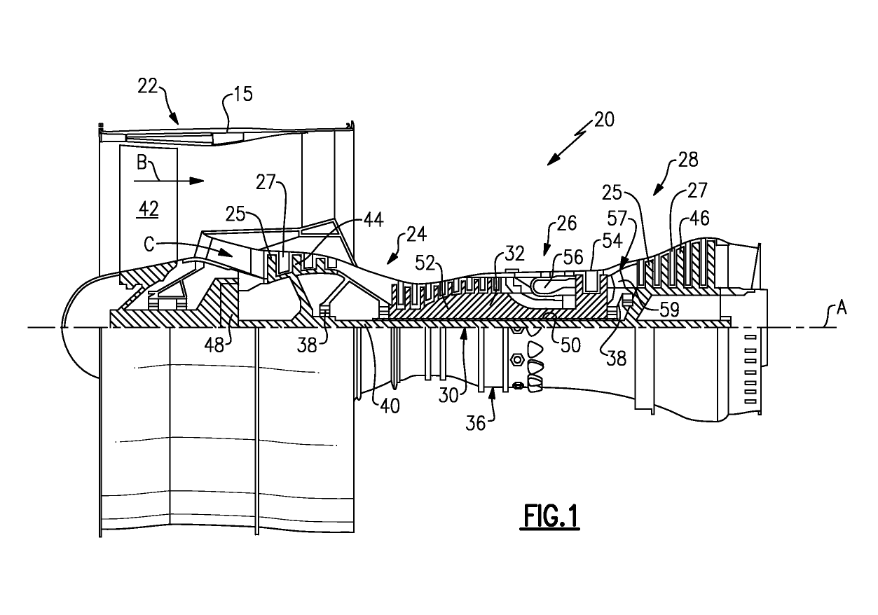

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine engine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second.

The compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 of the rotor assemblies create or extract energy (in the form of pressure) from the core air flow that is communicated through the gas turbine engine 20 along the core flow path C. The vanes 27 of the vane assemblies direct the core airflow to the blades 25 to either add or extract energy.

Various components of the gas turbine engine 20, such as airfoils of the blades 25 and the vanes 27 of the compressor section 24 and the turbine section 28, may be subjected to repetitive thermal cycling under widely ranging temperatures and pressures. The hardware of the turbine section 28 is particularly subjected to relatively extreme operating conditions. Therefore, some components may require internal cooling circuits for cooling the parts during engine operation. This disclosure relates to rotor blades having platform cooling passages that feed a cooling fluid through an outlet positioned at a mate face of the blade for impingement cooling a mate face of a circumferentially adjacent blade, thereby reducing oxidation caused by hot gas ingestion at the mate face gap between the adjacent blades.

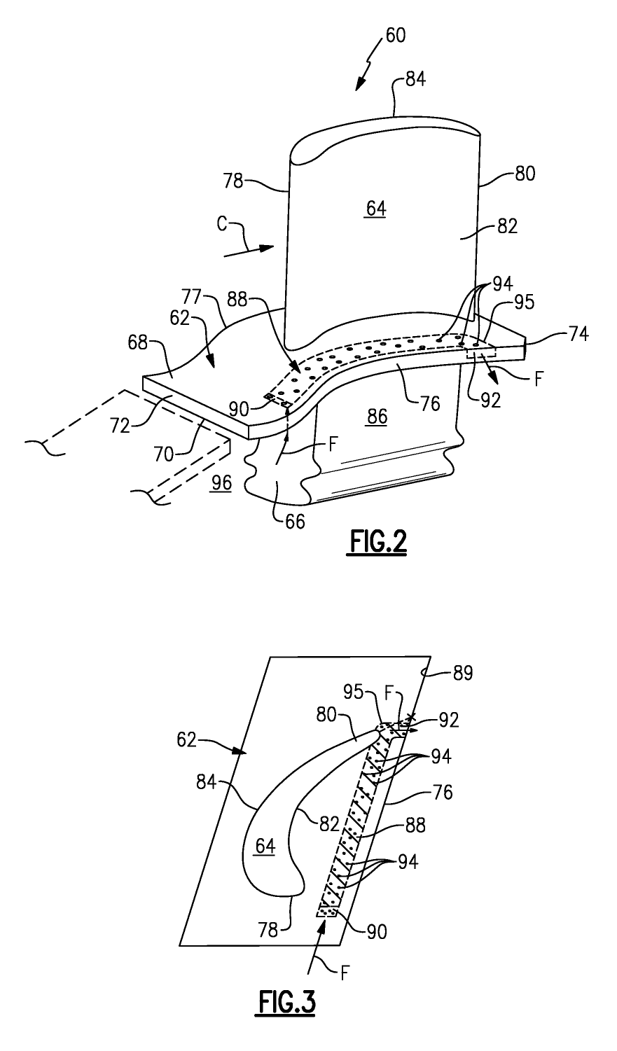

FIG. 2 illustrates a rotor blade 60 that can be incorporated into a gas turbine engine, such as the compressor section 24 or the turbine section 28 of the gas turbine engine 20 of FIG. 1. The rotor blade 60 may be part of a rotor assembly (not shown in FIG. 2) that includes a plurality of rotor blades circumferentially disposed about the engine centerline longitudinal axis A and configured to rotate to extract energy from the core airflow of the core flow path C.

The rotor blade 60 includes a platform 62, an airfoil 64 and a root 66. In one embodiment, the airfoil 64 extends from a gas path surface 68 of the platform 62 and the root 66 extends from a non-gas path surface 70 of the platform 62. In other words, the airfoil 64 and the root 66 extend in opposite directions from the platform 62. The gas path surface 68 is exposed to the hot combustion gases of the core flow path C, whereas the non-gas path surface 68 is remote from the core flow path C.

The platform 62 axially extends between a leading edge 72 and a trailing edge 74 and circumferentially extends between a first mate face 76 and a second mate face 77. The airfoil 64 axially extends between a leading edge 78 and a trailing edge 80 and circumferentially extends between a pressure side 82 and a suction side 84.

The root 66 is configured to attach the rotor blade 60 to a rotor assembly, such as within a slot formed in a rotor assembly. The root 66 includes a neck 86, which is, in one embodiment, an outer wall of the root 66.

The rotor blade 60 may include a platform cooling passage 88 that extends inside the platform 62 of the blade 60. For example, the platform cooling passage 88 could be a hollow portion of the platform 62. It should be understood that the rotor blade 60 could include additional cooling passages, cooling holes etc. as part of an overall cooling circuit for cooling the rotor blade 60.

In one embodiment, a cooling fluid F may be circulated through the platform cooling passage 88 for cooling the surfaces of the platform 62. Additional details of exemplary platform cooling passages are described in detail below with respect to FIGS. 3, 4, 5 and 6.

FIG. 3 (with continued reference to FIG. 2) illustrates a first embodiment of a platform cooling passage 88. In one embodiment, the platform cooling passage 88 is formed inside the platform 62 of the blade 60 in a casting process by using ceramic materials. In another embodiment, the platform cooling passage 88 is formed in a casting process by using refractory metal materials. In yet another embodiment, the platform cooling passage 88 can be formed using both ceramic and refractory metal materials.

In one non-limiting embodiment, the platform cooling passage 88 is disposed on a side of the platform 62 that is adjacent to the pressure side 82 of the airfoil 64. Alternatively, in another non-limiting embodiment, the platform cooling passage 88 may be disposed on a side of the platform 62 that is adjacent to the suction side 84 of the airfoil 64 (see FIG. 4).

The platform cooling passage 88 extends between an inlet 90 and an outlet 92. In one embodiment, the inlet 90 is an opening formed through the non-gas path surface 70 of the platform 62 and is located upstream from the leading edge 78 of the airfoil 64. The cooling fluid F is directed inside of the platform cooling passage 88 through the inlet 90.

In this embodiment, the outlet 92 is an opening disposed through the mate face 76 of the platform 62. The outlet 92 may be positioned at the trailing edge 80 of the airfoil 64. Stated another way, should the trailing edge 80 of the airfoil 64 be extended to an edge 89 of the platform 62, it would be at a position X. At the trailing edge 80 therefore means that the outlet 92 is through the mate face 76 at the same axial position as the position X. The position X could be defined as the dividing line between the pressure side 82 and the suction side 84 of the airfoil 64.

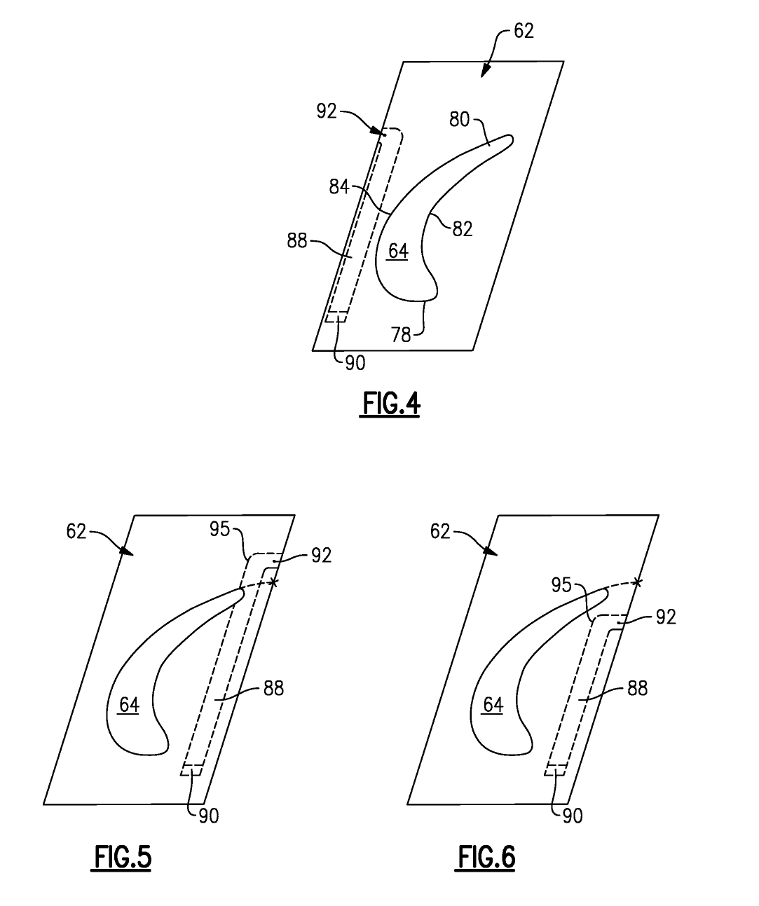

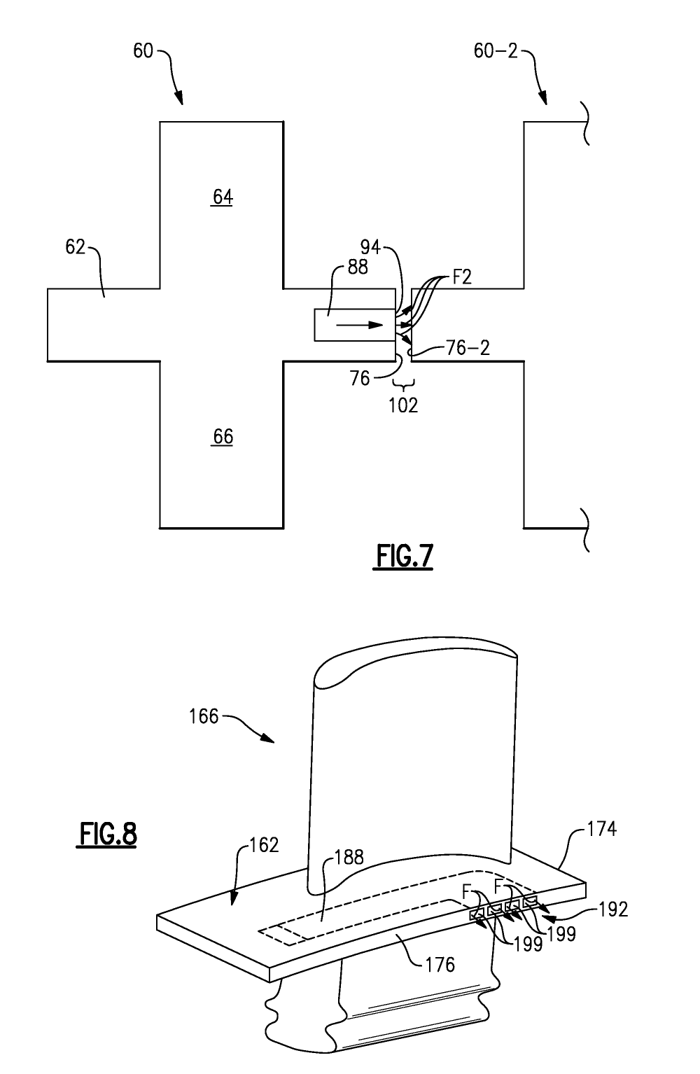

In another embodiment, the outlet 92 is positioned downstream of the trailing edge 80, or downstream from the position X (see FIG. 5). In an additional non-limiting embodiment, the outlet 92 of the platform cooling passage 88 is positioned upstream from the trailing edge 80, or upstream from the position X (see FIG. 6).

The platform cooling passage 88 may extend along a substantially liner path between the inlet 90 and the outlet 92. The platform cooling passage 88 could additionally include one or more curved sections 95. In one embodiment, the curved section 95 leads into the outlet 92 of the platform cooling passage 88.

One or more augmentation features 94 may be formed inside the platform cooling passage 88. The augmentation features 94 may alter a flow characteristic of the cooling fluid F that is circulated through the platform cooling passage 88 to cool the platform 62. Although shown schematically in FIGS. 2 and 3, the augmentation features 94 may include pin fins, trip strips, pedestals, guide vanes or any other feature that can be formed within the platform cooling passage 88 to manage stress, gas flow and heat transfer.

Referring to FIGS. 2 and 7, the cooling fluid F that feeds the platform cooling passage 88 may be extracted from a rim cavity such as a forward rim cavity 96. The forward rim cavity 96 is a pocket that extends radially inwardly from the platform 62 and is generally bound in the circumferential direction by the roots 66 of adjacent blades. Alternatively, in another embodiment, the inlet 90 of the platform cooling passage 88 is fed via a neck pocket 98 formed in the neck 86 of the root 66, as discussed in greater detail with respect to FIG. 9.

Once inside the platform cooling passage 88, the cooling fluid F may circulate over, around or through the augmentation features 94 prior to being expelled through the outlet 92. In one non-limiting embodiment, the cooling fluid F is expelled through the outlet 92 to provide a layer of film cooling air F2 at the mate face 76 (see FIG. 7). For example, the layer of film cooling air F2 expelled from the outlet 92 discourages hot combustion gases from the core flow path C from ingesting into the mate face gap 102 that extends between the mate face 76 of the blade 60 and a mate face 76-2 of a circumferentially adjacent blade 60-2.

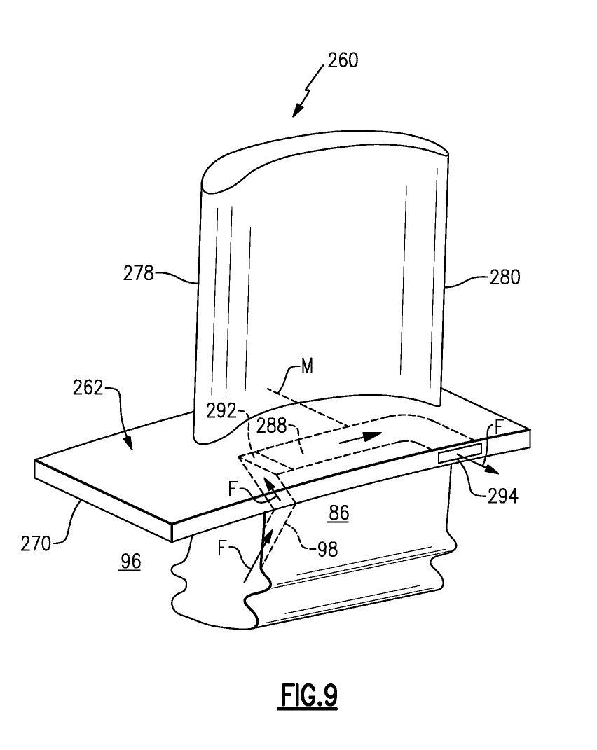

FIG. 8 illustrates another exemplary platform cooling passage 188 that can be provided within a rotor blade 160. In this disclosure, like reference numerals represent like features, whereas reference numerals modified by 100 are indicative of slightly modified features.

In this embodiment, an outlet 192 of the platform cooling passage 188 includes a plurality of outlet openings 199. The outlet openings 199 are formed through a mate face 176 of the platform 162 and are axially spaced from one another. The outlet openings 199 are generally disposed near a trailing edge 174 of the platform 162. A cooling fluid F may exit the platform cooling passage 188 through each outlet opening 199 to provide multiple layers of film cooling at the mate face 176.

FIG. 9 illustrates yet another embodiment of a platform cooling passage 288 for a rotor blade 260. This embodiment is similar to the FIG. 3 and FIG. 7 embodiments except that the platform cooling passage 288 is fed via a neck pocket 98 rather than the forward rim cavity 96. The neck pocket 98 establishes a passage between the forward rim cavity 96 and an inlet 292 of the platform cooling passage 288 that is disposed through a non-gas path surface 270 of the platform 262. In one non-limiting embodiment, the inlet 292 is positioned at some point between a leading edge 278 and a trailing edge 280 of the airfoil 264. In another embodiment, the inlet 292 is disposed between the leading edge 278 and a midpoint M of the airfoil 264.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A rotor blade, comprising:
a platform;
an airfoil that extends from said platform;
a platform cooling passage extending inside of said platform; and
said platform cooling passage including an inlet disposed through a non-gas path surface of said platform and an outlet disposed through a mate face of said platform.

2. The rotor blade as recited in claim 1, wherein said platform cooling passage includes a curved section that leads into said outlet.

3. The rotor blade as recited in claim 1, wherein said inlet is fed with a cooling fluid communicated through a neck pocket disposed in a neck of a root that extends from said platform.

4. The rotor blade as recited in claim 1, wherein said inlet is fed with a cooling fluid from a forward rim cavity.

5. The rotor blade as recited in claim 4, wherein said forward rim cavity is radially inward from said platform and is upstream from a root that extends from said platform.

6. The rotor blade as recited in claim 1, comprising at least one augmentation feature formed inside said platform cooling passage.

7. The rotor blade as recited in claim 1, wherein said outlet is positioned at a trailing edge of said airfoil.

8. The rotor blade as recited in claim 1, wherein said outlet is positioned upstream from a trailing edge of said airfoil.

9. The rotor blade as recited in claim 1, wherein said outlet is positioned downstream from a trailing edge of said airfoil.

10. The rotor blade as recited in claim 1, wherein said platform cooling passage is positioned adjacent to a pressure side of said airfoil.

11. The rotor blade as recited in claim 1, wherein said platform cooling passage is positioned adjacent to a suction side of said airfoil.

12. The rotor blade as recited in claim 1, wherein said outlet includes a plurality of outlet openings formed through said mate face.

13. A gas turbine engine, comprising:
a rotor blade including:
a platform;
an airfoil that extends from said platform;
a platform cooling passage extending inside of said platform; and
wherein said platform cooling passage includes an inlet fed with a cooling fluid from either a front rim cavity upstream of said rotor blade or a neck pocket formed through a root of said rotor blade and an outlet disposed through a mate face of said platform.

14. The gas turbine engine as recited in claim 13, wherein said inlet is disposed through a non-gas path surface of said platform upstream from a leading edge of said airfoil.

15. The gas turbine engine as recited in claim 13, wherein said inlet is disposed between a leading edge and a midpoint of said airfoil.

16. A method of cooling a platform of a rotor blade, comprising the steps of:
communicating a cooling fluid into an inlet of a platform cooling passage, the inlet formed in a non-gas path surface of the platform;
circulating the cooling fluid through the platform cooling passage to remove heat from the platform; and
expelling the cooling fluid through an outlet of the platform cooling passage, the outlet disposed through a mate face of the platform.

17. The method as recited in claim 16, wherein the step of communicating includes feeding the cooling fluid to the platform cooling passage from a forward rim cavity located radially inward of the platform.

18. The method as recited in claim 16, wherein the step of communicating includes feeding the cooling fluid through a neck pocket formed in a root of the rotor blade.

19. The method as recited in claim 16, comprising depositing a film cooling layer at the mate face to discourage gas ingestion into a mate face gap between adjacent rotor blades.

20. The method as recited in claim 16, wherein the step of circulating includes communicating the cooling fluid through a curved section of the platform cooling passage prior to the step of expelling.
